(19) United States
(12) Patent Application Publication
(10) Pub. No.: US 2019/0088384 A1
(43) Pub. Date: Mar. 21, 2019

(54) THERMALLY CONDUCTIVE INSULATOR

(71) Applicant: KABUSHIKI KAISHA TOSHIBA, Minato-ku (JP)

(72) Inventors: Takayuki FUKUSAWA, Yokohama (JP); Keiko ALBESSARD, Yokohama (JP); Takashi KUBOKI, Ota (JP); Yasuhiro GOTO, Minato-ku (JP)

(73) Assignee: KABUSHIKI KAISHA TOSHIBA, Minato-ku (JP)

(21) Appl. No.: 15/916,716

(22) Filed: Mar. 9, 2018

(30) Foreign Application Priority Data
Sep. 19, 2017 (JP) 2017-179071

(51) Int. Cl. H01B 3/02; H01B 3/00; H01B 17/64; C01B 21/068; C01B 32/956

(52) U.S. Cl. CPC H01B 3/025; H01B 3/004; C01B 32/956; C01B 21/068; H01B 17/64

(57) ABSTRACT

A thermally conductive insulator consisting essentially of a silicon nitride member, comprise: a first region provided 10 μm or more away from a first surface of the member along a depth direction in a section vertical to the first surface and containing at least one substance selected from the group consisting of silicon carbide and a carbon material; and a second region provided between the first surface and the first region. A concentration of silicon nitride of the second region is higher than a concentration of silicon nitride of the first region.

### CROSS REFERENCE TO RELATED APPLICATION

This application is based upon and claims the benefit of priority from Japanese Patent Application No. 2017-179071, filed on Sep. 19, 2017; the entire contents of which are incorporated herein by reference.

### FIELD

Embodiments described herein relate generally to a thermally conductive insulator.

### BACKGROUND

A ceramic containing silicon nitride as its main component is chemically stable and has excellent high-temperature heat resistance and mechanical properties, and thus its practical use as a high-temperature structural member has been in progress. Further, the above-described ceramic is excellent also in abrasion resistance, and thus has been widely utilized also as sliding members such as a bearing and a bearing material.

The above-described ceramic can exhibit a high coefficient of thermal conductivity by adding a sintering aid thereto, and thus has been expected to be utilized also as insulating heat dissipating materials such as a semiconductor substrate material in recent years. Aluminum nitride has been known as a material having insulation performance and a high coefficient of thermal conductivity, but has a problem in terms of reliability because its mechanical properties such as strength and toughness are low, cracking occurs in a ceramic in a member having a joint portion due to a difference in heat shrinkage, and the like. In its use for a substrate of a semiconductor or the like in particular, a heat value tends to increase due to high integration and high output of an element, and thus a silicon nitride material having excellent mechanical properties has been drawing attention. It is also necessary to endure heat generation close to 400° C. in the future, and thus the silicon nitride excellent in insulation resistance even at a temperature greater than 200° C. is the most suitable. However, the coefficient of thermal conductivity of the silicon nitride at present is insufficient as compared to the aluminum nitride and silicon carbide.

In order to achieve high thermal conduction of the silicon nitride, various attempts, which are to use a sintering aid that does not dissolve in silicon nitride particles, crystallize grain boundary phases, and the like, have been made so far. The silicon nitride has been known that its crystal structure causes phase transition from an α type to a β type in a sintering process and on this occasion, its particles grow to be a columnar shape. Due to this particle form change, the crystal structure changes to a structure such as a fiber-composite material, to thereby improve strength and fracture toughness as referred as to a self-reinforcing type. A silicon nitride particle having such a particle form has anisotropy of thermal conductivity, and has been reported that the coefficient of thermal conductivity in a c-axis direction theoretically, namely in a major axis direction of the particle is 450 W/m·K, which is high, and the coefficient of thermal conductivity in an a-axis direction, namely a minor axis direction of the particle is 170 W/m·K.

As described above, there has been considered a method in which silicon nitride particles are oriented in a thickness direction of a substrate to increase the coefficient of thermal conductivity in the thickness direction, but this method has problems such as a decrease in strength in a specific direction and difficulty of mass production. Therefore, there has been demanded a method capable of increasing the coefficient of thermal conductivity even when the orientation directions of the silicon nitride particles are random. The mechanical property such as strength and the coefficient of thermal conductivity have a tradeoff relationship. For example, when the grain growth is promoted in order to increase the coefficient of thermal conductivity, the strength decreases. As above, it has been difficult to achieve both a high coefficient of thermal conductivity and mechanical property with the silicon nitride simple substance.

In order to solve these problems, there has been known a method of laminating a highly thermal conductive ceramic on at least one surface of a metal substrate having a high coefficient of thermal conductivity. This makes it possible to achieve both high thermal conductivity and high insulation performance, but the metal material has a large thermal expansion coefficient, and thus is not suitable for a substrate to be bonded to another member.

### BRIEF DESCRIPTION OF THE DRAWINGS

FIG. 1 is a schematic cross-sectional view illustrating a structure example of a thermally conductive insulator according to an embodiment.

FIG. 2 is a schematic cross-sectional view illustrating another structure example of the thermally conductive insulator according to the embodiment.

### DETAILED DESCRIPTION

A thermally conductive insulator consisting essentially of a silicon nitride member, comprise: a first region provided 10 μm or more away from a first surface of the member along a depth direction in a section vertical to the first surface and containing at least one substance selected from the group consisting of silicon carbide and a carbon material; and a second region provided between the first surface and the first region. A concentration of silicon nitride of the second region is higher than a concentration of silicon nitride of the first region.

Hereinafter, an embodiment will be explained with reference to the drawings. Note that the drawings are schematic and, for example, dimensions such as thickness and width of components may differ from actual dimensions of the components. Besides, in the embodiment, substantially the same components are denoted by the same reference numerals and symbols and their explanations will be omitted in some cases.

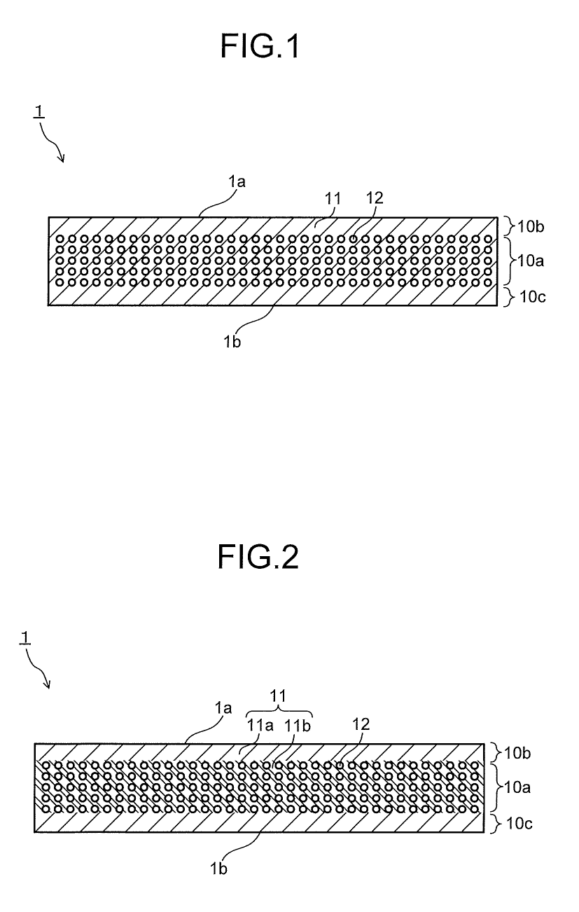

FIG. 1 is a schematic cross-sectional view illustrating a structure example of a thermally conductive insulator according to the embodiment. FIG. 1 illustrates a flat plate-shaped thermally conductive insulator, but to the thermally conductive insulator according to the embodiment, various shapes such as a flat plate shape and a cylindrical shape are applicable as usage.

A thermally conductive insulator 1 illustrated in FIG. 1 is made of a silicon nitride member, and has, of the above-described silicon nitride member, a surface 1a and a surface 1b facing the surface 1a. Incidentally, the silicon nitride member only needs to have at least one of the surface 1a and the surface 1b according to the shape of the thermally conductive insulator 1.

The thermally conductive insulator 1 includes a region 11 containing silicon nitride and at least one substance 12 selected from the group consisting of silicon carbide and a carbon material. The silicon nitride is most contained out of substances contained in the thermally conductive insulator 1 as a main component of the thermally conductive insulator 1. The substance 12 is dispersed away from the surface 1a and the surface 1b. At this time, the thermally conductive insulator 1 has a region 10a containing the silicon nitride, a region 10b being a composite region containing the silicon nitride and the substance 12, and a region 10c containing the silicon nitride. The region 10b is provided between the surface 1a and the region 10a, and the region 10c is provided between the surface 1b and the region 10a.

The concentration of the silicon nitride of the region 10a is 50 mass % or more, and is further preferred to be 70 mass % or more. The thickness of the region 10a is preferred to be 20 μm or more and 1000 μm or less. When the thickness is less than 20 μm, the effect obtained by introducing the substance 12 is not easily exhibited. When the thickness is greater than 1000 ram, thermal resistance increases, and thus it is not preferred. The silicon carbide and the carbon material each have a coefficient of thermal conductivity higher than that of the silicon nitride. The coefficient of thermal conductivity of the thermally conductive insulator 1 is 100 W/m·K or more and further preferred to be 110 W/m·K or more.

The region 10a contains fine particles of the substance 12, thereby being able to increase the mechanical properties. For example, fine silicon carbide particles are capable of suppressing grain growth of the silicon nitride to make the structure fine, to thus be preferred. Adding the silicon carbide and the carbon material makes it possible to expect that the thermal expansion coefficient of the thermally conductive insulator 1 increases, but the thermal expansion coefficient of the thermally conductive insulator 1 is preferred to be lower than 4×10⁻⁶/° C.

The shape of the silicon carbide and the carbon material is not limited in particular, and may be a particulate form, a short fibrous form, a plate-shaped particulate form, or a long fibrous form. The carbon material may be crystalline or amorphous. In terms of mechanical properties, a short fibrous form material such as a carbon nanotube (CNT) or carbon nanofiber (CNF) is preferably used as the carbon material.

The substance 12 is preferably introduced within a range that does not cause a large decrease in mechanical property, particularly, strength. Further, the substance 12 is preferably introduced so as to prevent the sinterability of raw materials from deteriorating when forming the thermally conductive insulator 1. The concentration of the substance 12 of the region 10a is preferred to be 0.2 mass % or more and 30 mass % or less. An appropriate added amount of the substance 12 varies according to the type of a material to be added. For example, in the case of the silicon carbide, the added amount is preferred to be 1 mass % or more and 30 mass % or less, and in the case of the carbon material, the added amount is preferred to be 0.2 mass % or more and 2 mass % or less.

The concentration of the silicon nitride of each of the region 10b and the region 10c is 70 mass % or more, and further preferred to be 90 mass % or more. The concentration of the silicon nitride of each of the region 10b and the region 10c is higher than that of the silicon nitride of the region 10a. The silicon carbide and the carbon material have electrical conductivity, and thus when the silicon carbide and the carbon material are dispersed over the entire thermally conductive insulator 1, the insulation performance of the thermally conductive insulator 1 decreases. In contrast to this, by forming at least one of the region 10b and the region 10c in which the silicon carbide and the carbon material hardly exist and that each have a concentration of the silicon nitride higher than that of the silicon nitride of the region 10a, high insulation performance of the thermally conductive insulator 1 can be secured. Concretely, the concentration of the substance 12 of each of the region 10b and the region 10c is preferred to be 0.25 mass % or less, for example, in the case of the silicon carbide, and is preferred to be 0.05 mass % or less, for example, in the case of the carbon material.

Each thickness of the region 10b and the region 10c is preferred to be 10 μm or more and 500 μm or less, and each volume resistivity of the region 10b and the region 10c is preferred to be 10¹⁴ Ω·cm or more. When the thickness is less than 10 μm, it becomes impossible to secure the insulation performance of the thermally conductive insulator 1. When the thickness exceeds 500 μm, the thermal resistance increases, and thus it is not preferred as a heat dissipating material.

In the case where each thickness of the region 10b and the region 10c is 10 μm or more and 500 μm or less, the region 10a is provided 10 μm or more and 500 μm or less away from the surface 1a of the silicon nitride member in the depth direction in a cross section vertical to the surface 1a and 10 μm or more 500 μm or less away from the surface 1b of the silicon nitride member in the depth direction in a cross section vertical to the surface 1b. In other words, the substance 12 is dispersed 10 μm or more and 500 μm or less away from the surface 1a in the depth direction and 10 μm or more and 500 μm or less away from the surface 1b in the depth direction.

The region 10b and the region 10c both are preferably formed in order to suppress a warp of the thermally conductive insulator 1, but only one of the region 10b and the region 10c may be formed. Even if the thermally conductive insulator 1 obtained after sintering is warped, the thermally conductive insulator 1 is subjected to a heat treatment again while being loaded a little, thereby making it possible to alleviate a residual stress to reduce the warp.

At least one of the region 10b and the region 10c preferably contains a sintering aid. As the sintering aid, a material having a composition that does not solid-dissolve in a silicon nitride particle is preferably used. This makes it possible to suppress phonon scattering, which is an obstructive factor of thermal conduction, to improve the coefficient of thermal conductivity. However, this does not apply to a trace component contained in a raw material powder.

The sintering aid contains at least one element selected from the group consisting of Mg, Ca, Sr, Ba, Y, La, Ce, Pr, Nd, Sm, Eu, Gd, Dy, Er, and Yb, for example. The concentration of the above-described element of each of the region 10b and the region 10c is preferred to be 0.5 mass % or more and 10 mass % or less. The sintering aid may contain an oxide of the above-described element, a nitride of the above-described, a carbide of the above-described element, or an oxynitride of the above-described element. These elements exist in grain boundary phases mainly. Among these elements, Mg, Ca, Sr, and Ba play a role in forming a liquid phase mainly, and rare-earth elements affect the grain growth of the silicon nitride mainly. When the above-described concentration is less than 0.5 mass %, it is not possible to sufficiently form the liquid phase at the time of sintering, resulting in that density decreases and strength becomes likely to decrease. When the above-described concentration exceeds 10 mass %, a grain boundary phase region existing at an interface between silicon nitride particles and at a triple point of the thermally conductive insulator 1 increases to be an obstructive factor of thermal conduction. Further, the grain boundary phases are crystallized, thereby making it possible to further improve the coefficient of thermal conductivity. In order to achieve this, an additive that promotes crystallization of a grain boundary glass phase, which is HfO₂ or the like, for example, may be added to the thermally conductive insulator 1.

The type of the sintering aid contained in the region 10a and the type of the sintering aid contained in the region 10b and the region 10c may be different from each other. FIG. 2 is a schematic cross-sectional view illustrating another structure example of the thermally conductive insulator. Incidentally, regarding the portions common to those in FIG. 1, the explanations in FIG. 1 can be cited appropriately.

A thermally conductive insulator 1 illustrated in FIG. 2 includes a region 11a and a region 11b as the region 11, and the substance 12. For example, the region 11a in the region 10a may have a sintering aid containing a first element, and the region 11b in the region 10b and the region 10c may have a sintering aid containing a second element different from the first element. As the second element, an element having a thermal expansion coefficient smaller than that of the first element is used, thereby making it possible to suppress occurrence of a compressive stress in the region 10b and the region 10c after sintering, resulting in that it is possible to make the thermally conductive insulator 1 less vulnerable to damage. The type of the sintering aid or an added amount thereof makes it possible to make the grain growth of silicon nitride occur to thereby increase the thermal conductivity, and to promote densification to thereby increase the strength. As above, even though the type and the amount of the sintering aid are changed, at the stage where a liquid phase is formed, diffusion occurs between the region 10a and the region 10b and between the region 10a and the region 10c, thereby making it possible to establish strong bonding therebetween. Accordingly, it is possible to suppress a decrease in strength of the thermally conductive insulator 1.

As described above, the thermally conductive insulator according to the embodiment has the first region containing the silicon nitride and at least one of the silicon carbide and the carbon material inside, and the second region containing the silicon nitride between the surface and the first region.

In the conventional method of controlling the orientation of silicon nitride particles to improve the coefficient of thermal conductivity, anisotropy of strength is also included, and manufacture in a process unsuitable for mass production is required. Further, the coefficient of thermal conductivity and the mechanical property have a tradeoff relationship generally, and there is a problem that when one is increased, the other decreases. Further, in the method of laminating a highly thermal conductive ceramic on a surface portion of a metal material, a thermal expansion coefficient ascribable to the metal material increases, and thus peeling at an interface portion and a problem in a portion bonding to another member occur and application of the method is difficult.

In contrast to this, in the thermally conductive insulator according to the embodiment, the first region and the second region are formed, thereby making it possible to achieve excellent mechanical properties, high thermal conductivity, and high insulation performance all. Further, because containing the silicon nitride as its main component, the thermally conductive insulator has a low thermal expansion coefficient and can be used without any problems even when it is combined with another material.

The thermally conductive insulator according to the embodiment can be applied to a heat dissipating material to be used for, for example, power control units for a hybrid vehicle, a plug-in hybrid vehicle, an electric vehicle, and industry, a system infrastructure such as a smart grid, a transportation apparatus motor control, an LED substrate, and so on. The heat dissipating material using the thermally conductive insulator according to the embodiment has insulation performance, high thermal conductivity and mechanical properties.

Next, there will be explained a manufacturing method example of the thermally conductive insulator 1. Incidentally, the manufacturing method example of the thermally conductive insulator 1 is applicable also to a manufacturing method example of an thermally conductive insulator having a shape different from that in FIG. 1. The manufacturing method example of the thermally conductive insulator 1 includes sheet forming and sintering.

In the sheet forming, a first sheet formed body for forming the region 10a and a pair of second sheet formed bodies for forming the region 10b and the region 10c are fabricated. In the fabrication of the first sheet formed body, a silicon nitride powder, a sintering aid, and at least one substance of silicon carbide and a carbon material are mixed by a method similar to that of the first sheet formed body to form a mixed powder. Then, a solvent, a dispersing agent, an organic binder, and the like are added to the obtained mixed powder to form a slurry, and by using a tape forming machine or the like, the first sheet formed body is fabricated from this slurry.

In the fabrication of the second sheet formed bodies, predetermined amounts of a silicon nitride powder and a sintering aid are weighed to be mixed, to then form a mixed powder. As a mixing method, for example, wet mixing enabling uniform mixing, or the like can be cited. The method is not limited to this, and a method using a ball mill, a planetary ball mill, a bead mill, or the like may be used. Further, dry mixing may be used as long as sufficient mixing is possible. Then, a solvent, a dispersing agent, an organic binder, and the like are added to the obtained mixed powder to form a slurry, and by using a tape forming machine or the like, the second sheet formed bodies are fabricated from this slurry.

Then, the first sheet formed body and the second sheet formed bodies are laminated, or the second sheet formed bodies sandwich the first sheet formed body vertically. Then, pressure-bonding and forming is performed and sintering is performed at a predetermined temperature, and thereby the first sheet formed body and the second sheet formed bodies are integrated to fabricate a sintered body. When heating is performed at the time of pressure bonding, the respective binders penetrate into each boundary between the first sheet formed body and the second sheet formed body, thereby making it possible to obtain a delaminate sintered body. Incidentally, the sintering may be performed with the binder and the like being left in a partially carbonized state at the time of degreasing.

The sintering temperature is 1700° C. or more and 1950° C. or less, and further preferred to be 1800° C. or more and 1900° C. or less. This temperature range makes it easy to obtain a dense sintered body, and it is possible to promote the grain growth of the silicon nitride to obtain high thermal conductivity characteristics. A holding time of the sintering is not limited in particular, but is preferred to be two hours or more and 10 hours or less. An atmosphere of the sintering is preferred to be a pressurized atmosphere of 0.2 MPa or more and 10 MPa or less so as to suppress decomposition of the silicon nitride.

The sintering aid contained in the first sheet formed body and the sintering aid contained in the second sheet formed bodies may be the same, or different. The both are sintered after being laminated, to thereby cause mass transfer between the formed bodies, and they are integrated completely, thereby making it possible to prevent distinct interfaces of the silicon nitride from being formed. This makes it possible to achieve high thermal conductivity and excellent mechanical properties.

In order to maintain the insulation performance of the thermally conductive insulator 1, it is necessary to form at least one of the region 10b and the region 10c each having a thickness of 10 μm or more and 500 μm or less as described previously. It is also possible to fabricate the region 10b and the region 10c so as to have a predetermined thickness at the time of manufacture, but in general sintering, evaporation of the sintering aid occurs, and thus a surface portion is likely to be porous. Each thickness of the region 10b and the region 10c may be adjusted by removing this portion and working.

The method of manufacturing the thermally conductive insulator according to the embodiment is not limited to the above-described method. For example, the thermally conductive insulator according to the embodiment can also be formed by forming a silicon nitride layer (corresponding to the regions 10b, 10c) on a surface of a composite base material (corresponding to the region 10a) containing silicon nitride and at least one of silicon carbide and a carbon material by using a gas phase method such as a chemical vapor deposition (CVD) method, or a method such as slurry application sintering or reaction sintering using a silicon material.

### EXAMPLE

### Example 1

A silicon nitride (Si₃N₄) powder, an Y₂O₃ powder having an average particle diameter of 0.7 μm as a sintering aid, and an MgO powder as a sintering aid were weighed at a mass ratio of 100:7:3, a silicon carbide (SiC) powder having an average particle diameter of 0.8 μm was added to them so as to be 10 mass %, and in an ethanol, wet mixing was performed for 100 hours using a silicon nitride ball, to then fabricate a mixed powder. Predetermined amounts of a solvent, a dispersing agent, and a binder were added to the obtained mixed powder to adjust a slurry, and by using a tape forming machine, a first sheet formed body having a thickness of about 2.5 mm was formed.

A Si₃N₄ powder, an Y₂O₃ powder having an average particle diameter of 0.7 μm as a sintering aid, and an MgO powder having an average particle diameter of 0.5 μm as a sintering aid were weighed at a mass ratio of 100:7:3, and in an ethanol, wet mixing was performed for 100 hours using a silicon nitride ball, to then fabricate a mixed powder. Predetermined amounts of a solvent, a dispersing agent, and a binder were added to the obtained mixed powder to adjust a slurry, and by using a tape forming machine, a pair of second sheet formed bodies each having a thickness of about 200 μm was formed.

The paired second sheet formed bodies sandwiched the first sheet formed body to form a laminate, and the laminate was pressurized to be pressure bonded, and then was punched and formed into an appropriate size. The laminate was sintered for six hours at 1900° C. under a pressured nitrogen atmosphere of 0.7 MPa to then fabricate an integrated thermally conductive insulator. Thereafter, as illustrated in Table 1, both surface portions were ground so as to have each thickness of second and third regions (the second sheet formed bodies) of 50 μm. The thickness was determined from the shrinkage percentage in the thickness direction when the second sheet formed bodies were sintered. In this test, because of the shrinkage percentage being 25%, each thickness of the second sheet formed bodies in the laminate was set to 150 μm and the surface portions on the both surfaces were ground for 100 μm.

The thermally conductive insulator was cut in an arbitrary surface vertical to the surface of the thermally conductive insulator, and a cross section was observed using a scanning electron microscope (SEM). The distance from the surface to a portion with the SiC particles existing in the depth direction was measured at 10 points, and an average value of the measured distances was set to the thickness of the second and third regions.

The obtained sintered body was cut into a size of 10 mm×10 mm and its coefficient of thermal conductivity was measured by a laser flash method. Results are illustrated in Table 1.

Each electrode was formed on the upper and lower surfaces of the sintered body worked into a plate shape and the current flowing through the inside of the sintered body was measured to thereby obtain the volume resistivity of the second and third regions. Results are illustrated in Table 1. Incidentally, in the case of the volume resistivity being 10¹⁴ Ω·cm or more, the insulation performance is evaluated as ◯ (Good) in Table 1, and in the case of the volume resistivity being less than 10¹⁴ Ω·cm, the insulation performance is evaluated as x (Bad) in Table 1.

### Example 2

The sintered body obtained in Example 1 was worked so as to have each thickness of the second and third regions of 15 μm by further griding the surface portions on the both surfaces of the plate material for 135 μm. Further, its coefficient of thermal conductivity and its volume resistivity were measured. Results are illustrated in Table 1.

### Comparative Example 1

A thermally conductive insulator composed of an Si₃N₄ material without SiC added thereto was fabricated by the same method as in Example 1. Further, its coefficient of thermal conductivity and its volume resistivity were measured. Results are illustrated in Table 1.

### Comparative Example 2

A thermally conductive insulator was fabricated under the conditions similar to those in Example 1 except that working was performed so as to have each thickness of the second and third regions of 7 μm as illustrated in Table 1. Further, its coefficient of thermal conductivity and its volume resistivity were measured. Results are illustrated in Table 1.

### Example 3

A thermally conductive insulator was fabricated under the conditions similar to those in Example 1 except that the added amount of the SiC particles in Example 1 was changed to 25 mass % as illustrated in Table 1. Further, its coefficient of thermal conductivity and its volume resistivity were measured. Results are illustrated in Table 1.

### Comparative Example 3

A thermally conductive insulator was fabricated under the conditions similar to those in Example 1 except that the added amount of the SiC particles in Example 1 was changed to 35 mass % as illustrated in Table 1. Further, its coefficient of thermal conductivity and its volume resistivity were measured. Results are illustrated in Table 1.

### Example 4

A thermally conductive insulator was fabricated under the conditions similar to those in Example 1 except that 0.25 mass % of CNF was added in place of the SiC particles in Example 1 as illustrated in Table 1. Further, its coefficient of thermal conductivity and its volume resistivity were measured. Results are illustrated in Table 1.

### Example 5

A thermally conductive insulator was fabricated under the conditions similar to those in Example 1 except that 1.5 mass % of CNF was added in place of the SiC particles in Example 1 as illustrated in Table 1. Further, its coefficient of thermal conductivity and its volume resistivity were measured. Results are illustrated in Table 1.

### Comparative Example 4

A thermally conductive insulator was fabricated under the conditions similar to those in Example 1 except that 0.15 mass % of CNF was added in place of the SiC particles in Example 1 as illustrated in Table 1. Further, its coefficient of thermal conductivity and its volume resistivity were measured. Results are illustrated in Table 1.

### Comparative Example 5

A thermally conductive insulator was fabricated under the conditions similar to those in Example 1 except that 3 mass % of CNF was added in place of the SiC particles in Example 1 as illustrated in Table 1. Further, its coefficient of thermal conductivity and its volume resistivity were measured. Results are illustrated in Table 1.

### Example 6

Second sheet formed bodies were fabricated with the same amounts as those and by the same method as in Example 1 except that an ytterbium oxide (Yb₂O₃) powder and a magnesium oxide (MgO) powder having an average particle diameter of 1.0 μm were used for the sintering aid in Example 1. Similarly, a first sheet formed body was fabricated by adding an Y₂O₃ powder and an MgO powder as the sintering aid and adding a SiC powder similarly to Example 1. These sheet formed bodies were laminated and sintered by the same method as in Example 1 to then obtain a sintered body. Surface portions on both surfaces of the obtained sintered body were ground for 100 μm, to then fabricate a thermally conductive insulator having second and third regions each having a thickness of 50 μm. Further, its coefficient of thermal conductivity and its volume resistivity were measured. Results are illustrated in Table 1.

Table 1 reveals that the first region (first sheet formed body) and the second and third regions are formed, and thereby the thermally conductive insulator has both high thermal conductivity and high insulation performance. Further, in the case where the added amount of at least one of the silicon carbide and the carbon material exceeded the appropriate range, the sintered density decreased and a large number of pores and cracks, which trigger a decrease in strength, occurred.

The thermally conductive insulator in Example 6 in which sintering aids different between the first region and the second, third regions were used has a coefficient of thermal conductivity of 115 W/m·K and high insulation performance. By using Yb₂O₃ for the sintering aid of the second and third regions, the grain growth of silicon nitride was promoted rather than an Y₂O₃-based sintering aid, and thereby the coefficient of thermal conductivity further improved.

In the case where MgO and a plurality of rare-earth elements were used as the sintering aid, it was confirmed that the first region has thermal conductivity higher than that of the second and third regions, similarly to Examples 1 and 6. It is found out that the rare-earth elements each have an effect of promoting the grain growth of the silicon nitride, and the similar effect can be obtained even when the rare-earth elements are used in the second and third regions, or in the first region. Further, test results reveal that the insulation performance in the thickness direction of the thermally conductive insulator is secured as long as each thickness of the second and third regions is 10 μm or more.

A cross section in the thickness direction of the thermally conductive insulator in Example 1 was SEM observed. A region including interfaces of the laminate was subjected to ion milling to then be observed. As a result, a fine silicon nitride structure in the interface between the first region and the second region and a fine silicon nitride structure in the interface between the first region and the third region were continuos, to thus fail to confirm a distinct interface. This indicates that the thermally conductive insulator has high mechanical properties. Further, it was found out that by the second and third regions existing, the thermal expansion coefficient is also suppressed to be 3.5×10⁻⁶/° C. and a value close to that of Si₃N₄.

TABLE 1

| | | Silicon | | | |
|---|---|---|---|---|---|
| | Thickness | Carbide•Carbon | | | |
| | of Second | Material | | Coefficient | |
| | and Third | | Added | of Thermal | Insulation |
| | Regions | | Amount | Conductivity | Perfor- |
| | (μm) | Type | (mass %) | (W/m · K) | mance |
| Example 1 | 50 | SiC | 10 | 110 | ∘ |
| Example 2 | 15 | SiC | 10 | 118 | ∘ |
| Example 3 | 50 | SiC | 25 | 120 | ∘ |
| Example 4 | 50 | CNF | 0.25 | 112 | ∘ |
| Example 5 | 50 | CNF | 1.5 | 118 | ∘ |
| Example 6 | 50 | SiC | 10 | 115 | ∘ |
| Comparative | 0 | — | — | 90 | ∘ |
| Example 1 | | | | | |
| Comparative | 7 | SiC | 10 | 120 | x |
| Example 2 | | | | | |
| Comparative | 50 | SiC | 35 | — | ∘ |
| Example 3 | | | | | |
| Comparative | 50 | CNF | 0.15 | 90 | ∘ |
| Example 4 | | | | | |
| Comparative | 50 | CNF | 3 | — | ∘ |
| Example 5 | | | | | |

Incidentally, while certain embodiments of the present invention have been described, these embodiments have been presented by way of example only, and are not intended to limit the scope of the inventions. Indeed, the novel methods described herein may be embodied in a variety of other forms; furthermore, various omissions, substitutions and changes in the form of the methods described herein may be made without departing from the spirit of the inventions. The accompanying claims and their equivalents are intended to cover such forms or modifications as would fall within the scope and spirit of the inventions.

What is claimed is:

1. A thermally conductive insulator consisting essentially of a silicon nitride member, comprising:
a first region provided 10 μm or more away from a first surface of the member along a depth direction in a section vertical to the first surface and containing at least one substance selected from the group consisting of silicon carbide and a carbon material; and
a second region provided between the first surface and the first region,
wherein a concentration of silicon nitride of the second region is higher than a concentration of silicon nitride of the first region.

2. The insulator according to claim 1,
wherein volume resistivity of the second region is 10¹⁴ Ω·cm or more.

3. The insulator according to claim 1,
wherein at least one selected from the group consisting of the first and second regions contains 0.5 mass % or more and 10 mass % or less of at least one element selected from the group consisting of Mg, Ca, Sr, Ba, Y, La, Ce, Pr, Nd, Sm, Eu, Gd, Dy, Er, and Yb.

4. The insulator according to claim 1,
wherein the first region contains 0.5 mass % or more and 10 mass % or less of at least one first element selected from the group consisting of Mg, Ca, Sr, Ba, Y, La, Ce, Pr, Nd, Sm, Eu, Gd, Dy, Er, and Yb, and
the second region contains 0.5 mass % or more and 10 mass % or less of at least one second element that is selected from the group consisting of Mg, Ca, Sr, Ba, Y, La, Ce, Pr, Nd, Sm, Eu, Gd, Dy, Er, and Yb and is different from the first element.

5. The insulator according to claim 1,
wherein a concentration of the substance of the first region is 0.2 mass % or more and 30 mass % or less.

6. The insulator according to claim 1,
wherein the silicon nitride member includes:
a second surface facing the first surface; and
a third region provided between the second surface and the first region,
wherein the first region is provided 10 μm or more away from the second surface along the depth direction in a section vertical to the second surface, and
a concentration of silicon nitride of the third region is higher than the concentration of the silicon nitride of the first region.

7. The insulator according to claim 1, wherein
a coefficient of thermal conductivity of the thermally conductive insulator is 100 W/m·K or more.
